(19) United States
(12) Patent Application Publication
(10) Pub. No.: US 2022/0105898 A1
(43) Pub. Date: Apr. 7, 2022

(54) VEHICLE WITH TAIL GATE AND METHOD OF CONTROLLING THE SAME

(71) Applicants: Hyundai Motor Company, Seoul (KR); Kia Corporation, Seoul (KR)

(72) Inventor: Daeyun An, Anyang (KR)

(21) Appl. No.: 17/410,396

(22) Filed: Aug. 24, 2021

(30) Foreign Application Priority Data
Oct. 7, 2020 (KR) 10-2020-0129503

(51) Int. Cl. B60R 25/24; B60R 25/01; G07C 9/00; G06K 7/10; B60Q 1/50; B60Q 5/00

(52) U.S. Cl. CPC B60R 25/245; B60R 25/01; G07C 9/00309; G06K 7/10306; G07C 2209/63; B60Q 5/00; B60R 2325/10; B60R 2325/20; B60Q 1/50

(57) ABSTRACT

A vehicle is configured to automatically open a tail gate by detecting a position of a smart key. The vehicle may include: a tail gate; an actuator configured to open or close the tail gate; a plurality of ultra wide band (UWB) modules configured to receive a UWB signal transmitted from a smart key; and a controller configured to determine a position of the smart key based on the UWB signal received through the plurality of UWB modules, and control the actuator to open the tail gate in response to a movement pattern of the smart key being matched with a preset pattern or a moving route of the smart key being matched with a preset route within a preset area.

### CROSS-REFERENCE TO RELATED APPLICATION

This application claims under 35 U.S.C. § 119 the benefit of Korean Patent Application No. 10-2020-0129503, filed on Oct. 7, 2020 in the Korean Intellectual Property Office, the entire contents of which are incorporated herein by reference.

### BACKGROUND

### 1. Technical Field

The present disclosure relates to a vehicle and a method of controlling the vehicle, more particularly, to the vehicle and the method of controlling the vehicle capable of automatically opening a tail gate by detecting a position of a smart key.

### 2. Description of the Related Art

In general, a vehicle is configured to travel on a road or track, and may be powered using gasoline (i.e., a fossil fuel), electricity, or the like as power source(s).

Recently, in order to increase convenience, a feature of automatically opening and closing a tail gate of a vehicle is increasingly available.

Specifically, in certain circumstances, even if a user does not input a manual command, the vehicle determines the user's intention to open the tail gate and automatically opens the tail gate.

Technology is required to accurately determine the user's intention to open the tail gate and to open the tail gate only as needed.

### SUMMARY

Therefore, it is an aspect of the present disclosure to provide a vehicle and a method for controlling the vehicle capable of detecting position of a smart key using an ultra wide band (UWB) module provided in a vehicle, and accurately determining a user's intention to open a tail gate based on a position of the smart key.

It is an aspect of the disclosure to provide a vehicle including: a tail gate; an actuator configured to open or close the tail gate; a plurality of UWB modules configured to receive an a UWB signal transmitted from a smart key; and a controller configured to determine a position of the smart key based on the UWB signal received through the plurality of UWB modules, and control the actuator to open the tail gate in response to a movement pattern of the smart key being matched with a preset pattern or a moving route of the smart key being matched with a preset route within a preset area.

The vehicle may further include a feedback apparatus, and the controller may be configured to control the feedback apparatus to provide a feedback indicating that the smart key has reached within the preset area in response to the smart key being reached at the preset area.

The feedback apparatus may include at least one of a lamp configured to provide visual feedback or a speaker configured to provide auditory feedback.

The lamp may include a tail lamp of the vehicle, and the controller may be configured to control the tail lamp to irradiate light to the preset area.

The preset pattern may be composed of a combination of movements having different directions.

The movements having different directions may have a minimum movement distance.

The preset route may include a route from a first point in the preset area to a second point spaced apart from the first point by a preset distance in the preset area.

The controller may be configured to control the tail lamp to irradiate light toward the first point and the second point.

The plurality of UWB modules may include a plurality of front UWB modules provided in a front based on a center of the vehicle and a plurality of rear UWB modules provided in a rear based on the center of the vehicle, and the controller may be configured to determine position of the smart key based on the UWB signal received from the plurality of rear UWB modules.

The controller may be configured to determine position of the smart key based on reception time of the UWB signal received from each of the plurality of UWB modules. It is an aspect of the disclosure to provide a method for controlling vehicle including:

receiving an ultra wide band (UWB) signal transmitted from a smart key by a plurality of UWB modules; determining a position of the smart key based on the UWB signal received through the plurality of UWB modules; and opening a tail gate in response to the movement pattern of the smart key being matched with the preset pattern or the moving route of the smart key being matched with the preset route within a preset area.

The method for controlling vehicle may further include providing a feedback indicating that the smart key has reached within the preset area in response to the smart key being reached at the preset area.

The providing of the feedback, may include at least of controlling the lamp to provide visual feedback; or controlling a speaker to provide auditory feedback.

The lamp includes a tail lamp of the vehicle, and the controlling of the lamp may include controlling the tail lamp to irradiate light to the preset area.

The preset pattern may be composed of a combination of movements having different directions.

The movements having different directions may have a minimum movement distance.

The preset route may include a route from a first point in the preset area to a second point spaced apart from the first point by a preset distance in the preset area.

The method for controlling vehicle may further include controlling a tail lamp to irradiate light toward the first point and the second point.

The plurality of UWB modules may include a plurality of front UWB modules provided in a front based on a center of the vehicle and a plurality of rear UWB modules provided in a rear based on the center of the vehicle, and the determining of the position of the smart key based on the UWB signal received through the plurality of UWB modules, may include determining position of the smart key based on the UWB signal received from the plurality of rear UWB modules.

The determining of the position of the smart key based on the UWB signal received through the plurality of UWB modules, may include determining the position of the smart key based on reception time of the UWB signal received from each of the plurality of UWB modules.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a top view showing an exterior of a vehicle according to an embodiment.

FIG. 2 is a control block diagram of a vehicle according to an embodiment.

FIG. 3 is a flowchart of a method for controlling a vehicle according to an embodiment.

FIG. 4 illustrates a situation in which a feedback apparatus of a vehicle is operated according to an embodiment.

FIG. 5 illustrates a situation in which a tail gate of a vehicle is automatically opened according to the first embodiment.

FIG. 6 illustrates a situation in which a tail gate of a vehicle is automatically opened according to the second embodiment.

FIG. 7 illustrates a situation in which a tail gate of a vehicle is automatically opened according to the third embodiment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROM's, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Advantages and features of the disclosed invention, as well as a method and apparatus for achieving them, will become apparent with reference to the embodiments described below with reference to the accompanying drawings. However, the disclosed invention is not limited to the embodiments disclosed below and may be implemented in various different forms. Only the disclosed embodiments are provided to complete the disclosure of the disclosed invention, and to fully inform the scope of the invention to those of ordinary skill in the art to which the disclosed invention belongs. The disclosed invention is only defined by the scope of the claims.

The terms used in the disclosed specification will be briefly described, and the disclosed invention will be described in detail.

As for terms used in the disclosed invention, general terms that are currently widely used as possible are selected while considering functions in the disclosed invention, but this may vary according to the intention or judicial precedent of a person skilled in the art, the emergence of new technologies, and the like. In addition, in certain cases, there are terms arbitrarily selected by the applicant, and in this case, the meaning of the terms will be described in detail in the description of the corresponding invention. Therefore, the terms used in the disclosed invention should be defined based on the meaning of the term and the overall contents of the disclosed invention, not a simple name of the term.

Hereinafter, embodiments of a vehicle and a control method thereof will be described in detail with reference to the accompanying drawings so that those of ordinary skill in the art to which the disclosed invention pertains can easily implement it. In addition, in order to clearly describe the invention disclosed in the drawings, parts not related to the description will be omitted. In addition, in the drawings, the same reference numerals denote the same components, and redundant descriptions thereof will be omitted.

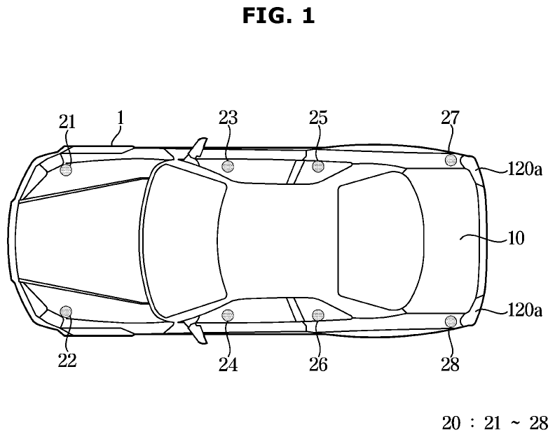

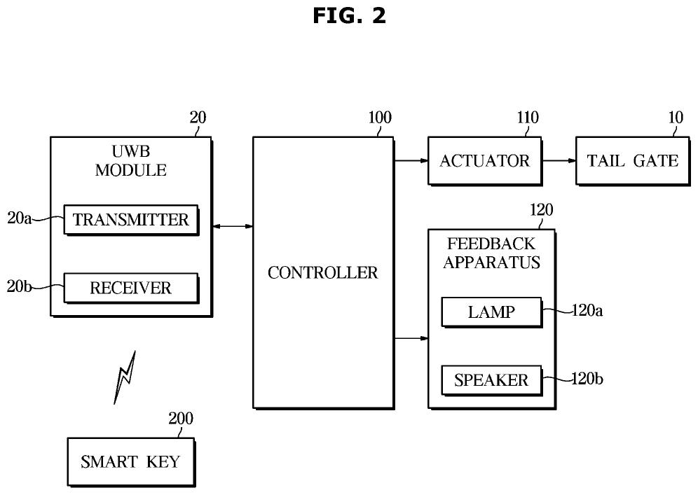

FIG. 1 is a top view showing an exterior of a vehicle according to an embodiment, and FIG. 2 is a control block diagram of a vehicle according to an embodiment.

Referring to FIGS. 1 and 2, the vehicle 1 according to an embodiment may include a tail gate 10 shielding the inside of the vehicle body from the outside or communicating the inside of the vehicle body with the outside and a plurality of Ultra Wide Band (UWB) modules 21 to 28.

The vehicle 1 according to an embodiment may include an actuator 110 that opens and closes the tail gate 10 and a feedback apparatus 120 that provides various types of feedback to a user.

The UWB module 20 according to an embodiment may include outdoor UWB modules 21, 22, 27, and 28 provided outside the vehicle 1, and indoor UWB modules 23, 24, 25, and 26 provided inside the vehicle 1.

However, the number and position of the UWB modules 20 are not limited thereto, and fewer or more UWB modules may be installed at various positions of the vehicle 1 according to the specifications or performance of the vehicle 1.

For convenience of explanation below, the UWB module 20 provided in a front based on a center of the vehicle 1 is referred to as the front UWB modules 21, 22, 23 and 24, and the UWB module 20 provided in a rear based on the center of the vehicle 1 is referred to as the rear UWB module 25, 26, 27and 28.

The UWB module 20 according to an embodiment may include a transmitter 20a and a receiver 20b.

The transmitter 20a may transmit a UWB signal (hereinafter referred to as an “authentication signal”) for communication with the smart key 200 of the vehicle 1, and the authentication signal may be a signal generated based on the UWB impulse signal.

The authentication signal transmitted by the transmitter 20a may refer to a response signal to UWB signal transmitted from the smart key 200, and the UWB signal and the response signal transmitted from the smart key 200 may include a preset data packet. The smart key 200 may transmit a re-response signal once again in response to the response signal transmitted from the UWB module 20. In this case, the UWB signal transmitted from the smart key 200 may also be a signal generated based on the UWB impulse signal.

In addition, the authentication signal transmitted by the transmitter 20a may refer to a search signal (Query) for searching the position of the smart key 200, and the smart key 200 may transmit a response signal including the preset data packet in response to the search signal transmitted from the transmitter 20a.

That is, the transmitter 20a may transmit an authentication signal in response to the receiver 20b receiving a UWB signal including a preset data packet from the smart key 200, and in this case, the smart key 200 may be an initiator, and the UWB module 20 may be a responder.

In addition, the transmitter 20a may transmit an authentication signal including the preset data packet according to the control of the controller 100 in response to a preset condition being satisfied or at each preset period, and in this case, the UWB module 20 may be an initiator and the smart key 200 may be a responder. The preset condition may include a situation in which an object around the vehicle 1 is sensed through a vehicle sensor.

The transmitter 20a may transmit the authentication signal in all directions.

The smart key 200 is an apparatus having a communication module capable of transmitting a UWB signal including a preset data packet corresponding to the vehicle 1, and may include an FOB key of the vehicle 1 and/or a user terminal. The user terminal may be interlocked with the vehicle 1 through communication with the vehicle 1, and may include a portable terminal capable of accessing the vehicle 1 through a network.

For example, the user terminal may include all kinds of handheld-based wireless communication apparatuses such as smart phones, and a wearable apparatus such as a watch, a ring, a bracelet, an anklet, a necklace, glasses, contact lenses, or a head-mounted-device (HMD).

The receiver 20b may include a reception antenna capable of receiving the UWB signal transmitted from the smart key 200 of the vehicle 1. For example, the antenna may include a UWB antenna.

The antenna of the receiver 20b may receive the UWB signal transmitted from the smart key 200. As described above, the UWB signal transmitted from the smart key 200 may refer to a signal transmitted every preset period from the smart key 200, or a re-response signal transmitted from the smart key 200 in response to the authentication signal output from the transmitter 20a.

The controller 100 may determine position of the smart key 200 based on the UWB signal received through each of the plurality of UWB modules 21 to 28. Specifically, since each of the plurality of UWB modules 21 to 28 is provided at different positions, arrival time points of the UWB signal received by each of the UWB modules 21 to 28 may be different from each other, and the controller 100 may determine the position of the smart key 200 by using the difference between the arrival time points.

Furthermore, in response to each of the plurality of UWB modules (21 to 28) transmitting a response signal (response signal) in response to the UWB signal (Poll signal) transmitted from the smart key 200, the smart key 200 may transmit a re-response signal (final signal) in response to the response signal, and the controller 100 may calculate the distance between each UWB module 21 to 28 and the smart key 200 based on the difference between transmission time of the response signal (response signal) and reception time of the re-response signal (final signal). At this time, if at least three UWB modules exist, the controller 100 may determine the exact position of the smart key 200 by employing a triangular positioning method.

In this way, the controller 100 may determine the position of the smart key 200 based on various positioning algorithms. As described above, the controller 100 may determine the position of the smart key 200 based on the time difference of arrival (TDoA) of the UWB signal, or the position of the smart key 200 based on a two way ranging (TWR) method. In addition, the controller 100 may determine the position of the smart key various positioning algorithms such as Angle of Arrival (AOA), Angle of Departure (AOD), Time of Arrival (TOA), or Time of Flight (TOF), and the algorithm for estimating the position of the smart key 200 is not limited thereto.

The controller 100 may control various components of the vehicle 1 based on the position of the smart key 200. For example, in response to the smart key 200 being detected for a preset time in the vicinity of the tail gate 10 of the vehicle 1, the controller 100 may open the tail gate 10 by controlling the actuator 110 that opens and closes the tail gate 10.

The actuator 110 according to an embodiment may include an actuator that opens and closes the tail gate 10 based on a control signal from the controller 100.

Specifically, the actuator 110 may include a driving motor that generates a driving force to open or close the tail gate 10 and a driving circuit that supplies driving power to the driving motor according to a control signal from the controller 100.

The driving motor may be supplied driving power from a driving circuit and convert the supplied driving power into rotational force.

For example, the rotational force generated by the drive motor may be transmitted to the tail gate 10 through a gear or the like. In other words, the drive motor may open or close the tail gate 10 through a gear or the like.

As another example, the rotational force generated by the driving motor may be transmitted to the tail gate 10 through a fluid and a piston. In other words, the driving motor may open or close the tail gate 10 through a piston or the like.

The driving circuit may supply driving power to open the tail gate 10 or supply driving power to close the tail gate 10 to the driving motor according to a control signal from the controller 100. For example, the driving circuit may supply a positive driving current to the driving motor to close the tail gate 10 and may supply a negative driving current to the driving motor to open the tail gate 10.

Such a driving circuit may include a switching element such as a relay for supplying driving power to the driving motor or blocking driving power, or an inverter circuit for controlling the opening speed or closing speed of the tail gate 10.

The actuator 110 may receive an open command of the tail gate 10 from the controller 100 and may open the tail gate 10 to a preset position in response to the open command.

As another example, the controller 100 may control the operation of the feedback apparatus 120 based on the position of the smart key 200.

As another example, the controller 100 may control the operation of the feedback apparatus 120 based on the position of the smart key 200.

The feedback apparatus 120 may include at least one of a lamp 120a for providing visual feedback or a speaker 120b for providing auditory feedback.

Specifically, the lamp 120a may refer to at least one of the head lamp or the tail lamp 120a of the vehicle 1, and more preferably, may refer to the tail lamp 120a of the vehicle 1.

The tail lamp 120a may refer to any apparatus provided in the rear of the vehicle 1 to irradiate light. For example, the tail lamp 120a may include a turn signal lamp, a stop lamp, a vehicle width lamp, a reverse lamp, a parking guide lamp, a license plate lamp, and a rear fog lamp.

In addition, the tail lamp 120a may include a guide or the like for irradiating light to a specific area of the ground.

The controller 100 may control the lamp 120a to provide visual feedback to the user in response to the smart key 200 being reached at a specific position. For example, in response to the smart key 200 being reached at the specific position, the controller 100 may flash a direction indicator by a predetermined number of times or operate a guide or the like.

The speaker 120b may refer to any apparatus capable of outputting various sounds. The controller 100 may control the speaker 120b to provide an auditory feedback to the user in response to the smart key 200 being reached at the specific position. For example, in response to the smart key 200 being reached at the specific position, the controller 100 may control the speaker 120b to output a preset sound.

The controller 100 for performing the above-described operation or an operation to be described later may be implemented as at least one memory (not shown) that stores an algorithm for controlling the operation of components in the vehicle 1 or data for a program that reproduces the algorithm, and at least one processor (not shown) that performs the above-described operation using data stored in at least one memory. In this case, at least one memory and at least one processor may be implemented as separate chips, respectively. Alternatively, the memory and processor may be implemented as a single chip.

In the above, the components of the vehicle 1 according to an embodiment have been described. Various components included in the vehicle 1 can communicate with each other through a communication network for the vehicle. Vehicle communication networks may adopt a communication protocol such as Media Oriented Systems Transport (MOST) with a maximum communication speed of 24.5 Mbps, FlexRay with a maximum communication speed of 10 Mbps, Controller Area Network (CAN) having a communication speed of 125 kbps to 1 Mbps, and Local Interconnect Network (LIN) having a communication speed of 20 kbps. The vehicle communication network can adopt a single communication protocol such as MOST, FlexRay, CAN, and LIN, as well as a plurality of communication protocols.

At least one component may be added or deleted in response to the performance of the components described above. In addition, it will be readily understood by those of ordinary skill in the art that the mutual positions of the components may be changed in response to the performance or structure of the system.

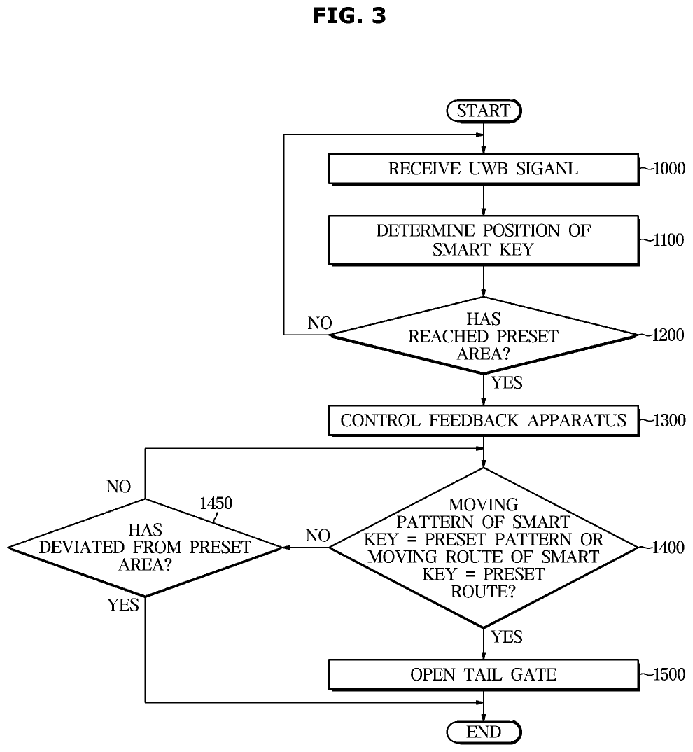

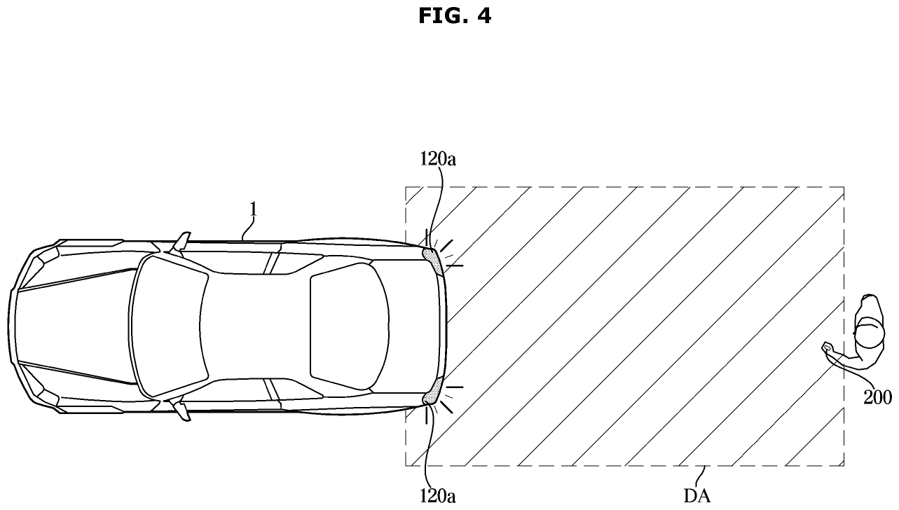

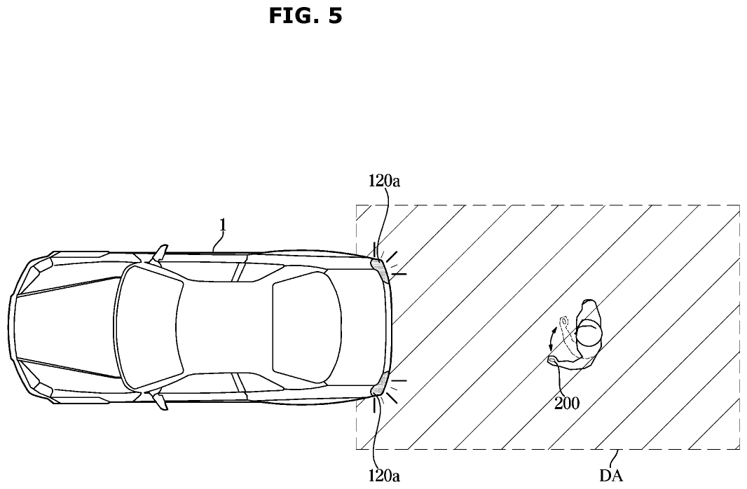

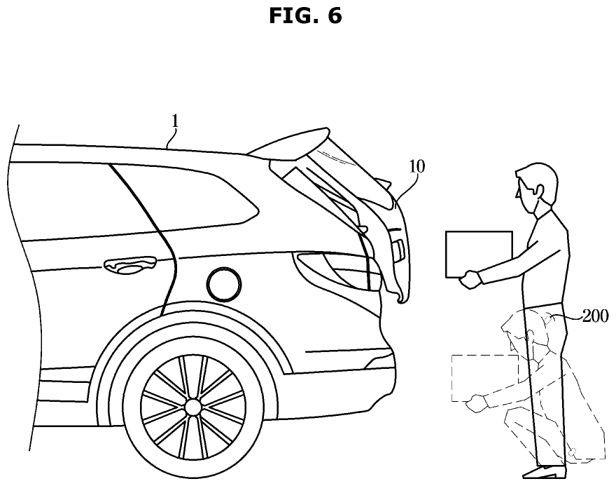

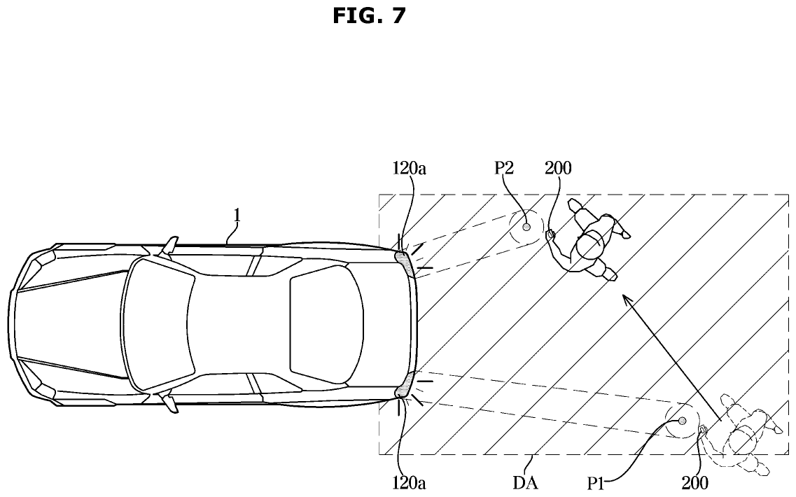

Hereinafter, a method of controlling the vehicle 1 according to an embodiment will be described with reference to FIGS. 3 to 7. FIG. 3 is a flowchart of a method for controlling a vehicle according to an embodiment, FIG. 4 illustrates a situation in which a feedback apparatus of a vehicle is operated according to an embodiment, FIG. 5 illustrates a situation in which a tail gate of a vehicle is automatically opened according to the first embodiment, FIG. 6 illustrates a situation in which a tail gate of a vehicle is automatically opened according to the second embodiment, and FIG. 7 illustrates a situation in which a tail gate of a vehicle is automatically opened according to the third embodiment.

Referring to FIG. 3, a plurality of UWB modules 20 may receive UWB signal transmitted from the smart key 200 (1000). The controller 100 may determine the position of the smart key 200 based on the UWB signal received through the plurality of UWB modules 20 (1100).

In this case, the controller 100 may determine the position of the smart key 200 based on the UWB signal received from the plurality of rear UWB modules 25 to 28. This is to more accurately detect a user holding a smart key 200 coming from the rear.

The controller 100 may determine whether the smart key 200 has reached a preset area DA by continuously tracking the position of the smart key 200 (1200). The preset area DA may refer to an area within a specific coordinate range stored in the memory of the controller 100.

The preset area DA may be set as the rear area of the vehicle 1, and may be set as a rectangular area having a width similar to the width of the vehicle 1 and a length similar to the overall length of the vehicle 1, but is not limited thereto.

The preset area DA may be changed according to a user's setting, and may be stored in the memory of the controller 100.

Referring to FIG. 4, in response to the user being reached at the preset area DA while holding the smart key 200 (example of 1200), the controller 100 may control the feedback apparatus 120 to provide a feedback indicating that the smart key 200 has reached within the preset area DA (1300).

For example, in response to the smart key 200 being reached at the preset area DA, the controller 100 may control the speaker 120b to output a preset sound. The user can recognize that the user has reached the preset area DA by recognizing the sound output from the speaker 120b.

As another example, the controller 100 may control the lamp 120a to irradiate light in response to the smart key 200 being reached at the preset area DA. The user may recognize that the user has reached the preset area DA by recognizing the light output from the lamp 120a.

More specifically, the controller 100 may control the tail lamp 120a to irradiate light to the preset area DA. That is, the tail lamp 120a irradiates light to the preset area DA of the ground, so that the user may recognize the area in which a specific action must be taken in order to open the tail gate 10.

In response to the smart key 200 being reached at the preset area DA, the controller 100 may determine whether the movement pattern of the smart key 200 matches the preset pattern or the moving route of the smart key 200 matches the preset route within the preset area DA (1400).

In response to the movement pattern of the smart key 200 being matched with the preset pattern within the preset area DA, or the moving route of the smart key 200 being matched with the preset route (example of 1400), the controller 100 may control the actuator 110 to open the tail gate 10 (1500).

In response to the movement pattern of the smart key 200 being not matched with the preset pattern and the smart key 200 deviates from the preset area DA while the moving route of the smart key 200 does not match the preset route (example of 1450), the controller 100 may terminate this process without performing any operation.

The preset pattern may refer to a set of a plurality of movements, and may be stored in a memory of the controller 100.

The preset pattern may be composed of a combination of movements having different directions. As an example, the preset pattern may be composed of a combination of movements having opposite directions. Specifically, the preset pattern may be composed of a combination of a left-to-right movement and a right-to-left movement, or may be composed of a combination of an upward-to-lower movement and a lower-to-upward movement.

The above-described preset pattern is only an example, and various patterns may be employed as the preset pattern, which may be changed according to a user's setting.

Referring to FIG. 5, the user may enter the preset area DA while holding the smart key 200, and may shake his hand in the left and right directions while holding the smart key 200 within the preset area DA.

In response to the user being shake his hand left and right while holding the smart key 200, the smart key 200 has a left-to-right movement and a right-to-left movement, and accordingly, a movement pattern of the smart key 200 may match a preset pattern.

In response to the movement pattern of the smart key 200 being matched with a preset pattern, the controller 100 may open the tail gate 10 by controlling the actuator 110.

That is, the user may open the tail gate 10 by shaking the hand holding the smart key 200 in the left and right directions.

Of course, the user may open the tail gate 10 by moving the smart key 200 back and forth in the left and right directions while putting the smart key 200 in the pocket.

Referring to FIG. 6, the user can sit and rise with the smart key 200 in his pocket, even if the user is holding his luggage with both hands.

In response to the user being sit and wake up while holding the smart key 200, the smart key 200 has a movement from an upper side to a lower side and a movement from a lower side to an upper side, and accordingly, a movement pattern of the smart key 200 may match a preset pattern.

In response to the movement pattern of the smart key 200 being matched with a preset pattern, the controller 100 may open the tail gate 10 by controlling the actuator 110.

That is, the user may open the tail gate 10 by sitting and standing up while holding the smart key 200.

Of course, the user may open the tail gate 10 by shaking the hand holding the smart key 200 in the vertical direction.

As described above, the preset pattern is composed of a combination of movements having different directions, so that the controller 100 can more clearly determine the user's intention to open the tail gate 10.

In other words, if the preset pattern consists of movements having one direction, there may be a problem in that the tail gate 10 is automatically opened by simply walking around the tail gate 10 without the intention of opening the tail gate 10 by the user.

In addition, movements having different directions constituting a preset pattern may have a minimum movement distance. For example, the minimum movement distance may be set to about 50 cm, but is not limited thereto.

This is because reliability is insufficient for movements with a movement distance shorter than 50 cm. In other words, if the preset pattern consists of movements with a movement distance shorter than 50 cm, there may be a problem in that the tail gate 10 is automatically opened by simply walking around the tail gate 10 without the intention of opening the tail gate 10 by the user.

Referring to FIG. 7, a preset route may include a route from the first point P1 in the preset area DA to the second point P2 spaced apart from the first point P1 by a preset distance in the preset area DA.

The preset route may be set as a route connecting not only two points but also more points, and each of the points may be stored in the memory of the controller 100. In addition, points for setting a preset route may be changed according to a user's setting.

The user may walk from the first point P1 to the second point P2 while holding the smart key 200, and accordingly, the moving route of the smart key 200 may coincide with a preset route.

Accordingly, the controller 100 may open the tail gate 10 by controlling the actuator 110.

That is, the user can open the tail gate 10 by simply walking from the first point P1 to the second point P2 while holding the smart key 200.

In order for the user to more easily recognize the first point (P1) and the second point (P2), the controller 100 may control the tail lamp 120a to irradiate light toward the first point P1 and the second point P2.

The tail lamp 120a for this may be a guide lamp for irradiating light in a specific direction.

In response to the light irradiated from the tail lamp 120a being projected onto the ground, the user may open the tail gate 10 by walking through the area irradiated with the light.

According to the third embodiment, even if the user may not use both hands, the tail gate 10 may be easily opened with a clear intention.

In response to the position of the smart key 200 being deviate from the preset area DA or moves to the inside of the vehicle 1 after the tail gate 10 is opened, the controller 100 closes the tail gate 10. The actuator 110 can be controlled.

According to the present disclosure, by opening the tail gate only in response to the user being have a clear intention, a situation in which the tail gate is automatically opened irrespective of the user's intention may be prevented.

In addition, users who may not use their hands may clearly express the intention to open the tail gate.

In addition, the user's intention may be grasped only by the position of the smart key without the operation of other vehicle sensors.

Meanwhile, some components of the vehicle 1 may be software and/or hardware components such as Field Programmable Gate Array (FPGA) and Application Specific Integrated Circuit (ASIC).

According to the present disclosure, it is possible to improve the usability of the UWB module by detecting an obstacle using the UWB module in a situation in which the tail gate is automatically opened and closed.

In addition, according to the present disclosure, it is possible to effectively prevent a collision between a tail gate and an obstacle in a situation in which the tail gate is automatically opened and closed.

On the other hand, the disclosed exemplary embodiments may be implemented in a form of a recording medium for storing instructions executable by a computer. Instructions may be stored in a form of program code and, when executed by a processor, may generate a program module to perform the operations of the disclosed exemplary embodiments. The recording medium may be implemented as a computer-readable recording medium.

The computer-readable recording medium includes all kinds of recording media in which instructions which may be decoded by a computer. For example, there may be read only memory (ROM), random access memory (RAM), a magnetic tape, a magnetic disk, a flash memory, an optical data storage device, and the like.

According to the present disclosure, it is possible to prevent a situation in which the tail gate is automatically opened regardless of the intention of the user.

In addition, according to the present disclosure, a user who may not use a hand may clearly express the intention of opening the tail gate.

As described above, the disclosed exemplary embodiments have been described with reference to the accompanying drawings. Although example embodiments of the present invention have been shown and described, it would be appreciated by those skilled in the art that changes may be made to these embodiments without departing from the principles and spirit of the present invention, the scope of which is defined in the claims and their equivalents.

What is claimed is:

1. A vehicle comprising:
a tail gate;
an actuator configured to open or close the tail gate;
a plurality of ultra wide band (UWB) modules configured to receive a UWB signal transmitted from a smart key; and
a controller configured to:
determine a position of the smart key based on the UWB signal received through the plurality of UWB modules; and
control the actuator to open the tail gate in response to a movement pattern of the smart key being matched with a preset pattern or a moving route of the smart key being matched with a preset route within a preset area.

2. The vehicle according to claim 1, further comprising a feedback apparatus, wherein the controller is configured to control the feedback apparatus to provide a feedback indicating that the smart key has reached within the preset area in response to the smart key being reached at the preset area.

3. The vehicle according to claim 2, wherein the feedback apparatus includes at least one of a lamp configured to provide visual feedback or a speaker configured to provide auditory feedback.

4. The vehicle according to claim 3, wherein the lamp includes a tail lamp of the vehicle, and the controller is configured to control the tail lamp to irradiate light to the preset area.

5. The vehicle according to claim 1, wherein the preset pattern is composed of a combination of movements having different directions.

6. The vehicle according to claim 1, wherein the movements having different directions have a minimum movement distance.

7. The vehicle according to claim 1, wherein the preset route includes a route from a first point in the preset area to a second point spaced apart from the first point by a preset distance in the preset area.

8. The vehicle according to claim 7, further comprising a tail lamp, wherein the controller is configured to control the tail lamp to irradiate light toward the first point and the second point.

9. The vehicle according to claim 1, wherein:
the plurality of UWB modules include a plurality of front UWB modules provided in a front based on a center of the vehicle and a plurality of rear UWB modules provided in a rear based on the center of the vehicle, and
the controller is configured to determine the position of the smart key based on the UWB signal received from the plurality of rear UWB modules.

10. The vehicle according to claim 1, wherein the controller is configured to determine the position of the smart key based on reception time of the UWB signal received from each of the plurality of UWB modules.

11. A method for controlling a vehicle, comprising:
receiving a UWB signal transmitted from a smart key by a plurality of UWB modules;
determining a position of the smart key based on the UWB signal received through the plurality of UWB modules; and
opening a tail gate in response to the movement pattern of the smart key being matched with the preset pattern or the moving route of the smart key being matched the preset route within a preset area.

12. The method according to claim 11, further comprising: providing a feedback indicating that the smart key has reached within the preset area in response to the smart key being reached at the preset area.

13. The method according to claim 12, wherein providing of the feedback, includes at least of controlling the lamp to provide visual feedback; or controlling a speaker to provide auditory feedback.

14. The method according to claim 13, wherein
the lamp includes a tail lamp of the vehicle, and
the controlling of the lamp includes controlling the tail lamp to irradiate light to the preset area.

15. The method according to claim 11, whereinthe preset pattern is composed of a combination of movements having different directions.

16. The method according to claim 15, whereinthe movements having different directions have a minimum movement distance.

17. The method according to claim 11, wherein the preset route includes a route from a first point in the preset area to a second point spaced apart from the first point by a preset distance in the preset area.

18. The method according to claim 17, further comprising: controlling a tail lamp to irradiate light toward the first point and the second point.

19. The method according to claim 11, wherein:
the plurality of UWB modules include a plurality of front UWB modules provided in a front based on a center of the vehicle and a plurality of rear UWB modules provided in a rear based on the center of the vehicle, and
determining the position of the smart key based on the UWB signal received through the plurality of UWB modules, includes determining position of the smart key based on the UWB signal received from the plurality of rear UWB modules.

20. The method according to claim 11, wherein determining the position of the smart key based on the UWB signal received through the plurality of UWB modules, includes determining the position of the smart key based on reception time of the UWB signal received from each of the plurality of UWB modules.
